(19) United States
(12) Patent Application Publication
(10) Pub. No.: US 2025/0031197 A1
(43) Pub. Date: Jan. 23, 2025

(54) BEAM REPORTING

(71) Applicant: Nokia Technologies Oy, Espoo (FI)

(72) Inventors: Yong LIU, Shanghai (CN); Daniel MEDINA, Munich (DE); Torsten WILDSCHEK, Gloucester (GB); Stepan KUCERA, Munich (DE)

(21) Appl. No.: 18/775,763

(22) Filed: Jul. 17, 2024

(30) Foreign Application Priority Data
Jul. 19, 2023 (WO) PCT/CN2023/108233

(51) Int. Cl. H04W 72/044; H04W 72/542

(52) U.S. Cl. CPC H04W 72/046; H04W 72/542

(57) ABSTRACT

Embodiments of the present disclosure relate to beam reporting. In an aspect, a first terminal device determines usability of at least one of a plurality of beams associated with at least one reference signal transmitted by a second terminal device based on measured signal level and/or quality; carries out beam-wise comparison among the at least one of the plurality of the beams determined usable, wherein the beam-wise comparison is based on the measured signal level and/or quality for identifying at least one beam having most suitable signal level and/or quality for signal transmission, and transmits, to the second terminal device, an indication indicating at least one of the following: the at least one beam having the most suitable signal level and/or quality; or the at least one of the plurality of beams being usable. The embodiments of the present disclosure can cause fast beam reporting.

### FIELD

Various example embodiments relate to the field of communications and in particular, to methods, terminal devices, apparatuses and a computer readable storage medium for beam reporting.

### BACKGROUND

In the communications area, there is a constant evolution ongoing in order to provide efficient and reliable solutions for utilizing wireless communication networks. Each new generation has it owns technical challenges for handling the different situations and processes that are needed to connect and serve devices connected to the wireless network. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

In recent communication technologies, for example, in RAN #94-e, the WID on NR (new radio) sidelink evolution was agreed, and it was most recently revised in RAN #99 (RP-230077). The WID includes the following objective for sidelink operation in FR2: study enhanced sidelink operation on FR2 licensed spectrum [RAN1, RAN2] (Determine in RAN #98-e whether to continue the study or study+specification work for FR2 until the end of R18). Focus only on updating the evaluation methodology for commercial deployment scenario in 4Q 2022. [RAN1]. Study is limited to the support of sidelink beam management (including initial beam-pairing, beam maintenance, and beam failure recovery, etc.) by reusing existing sidelink CSI framework and reusing Uu beam management concepts wherever possible. [RAN1, RAN2]. Beam management in FR2 licensed spectrum considers sidelink unicast communication only.

### SUMMARY

In general, example embodiments of the present disclosure provide a solution for beam reporting.

In a first aspect, there is provided a first terminal device. The first terminal device comprises at least one processor; and at least one memory including computer program codes; the at least one memory and the computer program codes are configured to, with the at least one processor, cause the device to determine usability of at least one of a plurality of beams associated with at least one reference signal transmitted by a second terminal device based on measured signal level and/or quality; carry out beam-wise comparison among the at least one of the plurality of the beams determined usable, wherein the beam-wise comparison is based on the measured signal level and/or quality for identifying at least one beam having most suitable signal level and/or quality for signal transmission; and transmit, to the second terminal device, an indication indicating at least one of the following: the at least one beam having the most suitable signal level and/or quality; or the at least one of the plurality of beams being usable.

In a second aspect, there is provided a second terminal device. The second terminal device comprises at least one processor; and at least one memory including computer program codes; the at least one memory and the computer program codes are configured to, with the at least one processor, cause the device to transmit, to a first terminal device, at least one reference signal associated with at least one of a plurality of beams; monitor, from the first terminal device, an indication indicating at least one of the following: at least one beam having most suitable signal level and/or quality among the plurality of beams; or the at least one of the plurality of beams being usable; and determine, based on the monitoring, one or more of the at least one of a plurality of beams for signal transmission.

In a third aspect, there is provided a method implemented at a first terminal device. The method comprises determining, at a first terminal device, usability of at least one of a plurality of beams associated with at least one reference signal transmitted by a second terminal device based on measured signal level and/or quality; carrying out beam-wise comparison among the at least one of the plurality of the beams determined usable, wherein the beam-wise comparison is based on the measured signal level and/or quality for identifying at least one beam having most suitable signal level and/or quality for signal transmission; and transmitting, to the second terminal device, an indication indicating at least one of the following: the at least one beam having the most suitable signal level and/or quality; or the at least one of the plurality of beams being usable.

In a fourth aspect, there is provided a method implemented at a second terminal device. The method comprises transmitting, at a second terminal device and to a first terminal device, at least one reference signal associated with at least one of a plurality of beams; monitoring, from the first terminal device, an indication indicating at least one of the following: at least one beam having most suitable signal level and/or quality among the plurality of beams; or the at least one of the plurality of beams being usable; and determining, based on the monitoring, one or more of the at least one of a plurality of beams for signal transmission.

In a fifth aspect, there is provided an apparatus comprising means for determining, at a first terminal device, usability of at least one of a plurality of beams associated with at least one reference signal transmitted by a second terminal device based on measured signal level and/or quality; means for carrying out beam-wise comparison among the at least one of the plurality of the beams determined usable, wherein the beam-wise comparison is based on the measured signal level and/or quality for identifying at least one beam having most suitable signal level and/or quality for signal transmission; and means for transmitting, to the second terminal device, an indication indicating at least one of the following: the at least one beam having the most suitable signal level and/or quality; or the at least one of the plurality of beams being usable.

In sixth aspect, there is provided an apparatus comprising means for transmitting, at a second terminal device and to a first terminal device, at least one reference signal associated with at least one of a plurality of beams; means for monitoring, from the first terminal device, an indication indicating at least one of the following: at least one beam having most suitable signal level and/or quality among the plurality of beams; or the at least one of the plurality of beams being usable; and means for determining, based on the monitoring, one or more of the at least one of a plurality of beams for signal transmission.

In a seventh aspect, there is provided a non-transitory computer readable medium comprising program instructions for causing an apparatus to perform at least the method according to any one of the above third to fourth aspect.

In an eight aspect, there is provided a computer program comprising instructions, which, when executed by an apparatus, cause the apparatus at least to: determine usability of at least one of a plurality of beams associated with at least one reference signal transmitted by a second terminal device based on measured signal level and/or quality; carry out beam-wise comparison among the at least one of the plurality of the beams determined usable, wherein the beam-wise comparison is based on the measured signal level and/or quality for identifying at least one beam having most suitable signal level and/or quality for signal transmission; and transmit, to the second terminal device, an indication indicating at least one of the following: the at least one beam having the most suitable signal level and/or quality; or the at least one of the plurality of beams being usable.

In a ninth aspect, there is provided a computer program comprising instructions, which, when executed by an apparatus, cause the apparatus at least to: transmit, to a first terminal device, at least one reference signal associated with at least one of a plurality of beams; monitor, from the first terminal device, an indication indicating at least one of the following: at least one beam having most suitable signal level and/or quality among the plurality of beams; or the at least one of the plurality of beams being usable; and determine, based on the monitoring, one or more of the at least one of a plurality of beams for signal transmission.

In a tenth aspect, there is provided a second terminal device. The first terminal device comprises: determining circuitry configured to determine usability of at least one of a plurality of beams associated with at least one reference signal transmitted by a second terminal device based on measured signal level and/or quality; carrying out circuitry configured to carry out beam-wise comparison among the at least one of the plurality of the beams determined usable, wherein the beam-wise comparison is based on the measured signal level and/or quality for identifying at least one beam having most suitable signal level and/or quality for signal transmission; and transmitting circuitry configured to transmit, to the second terminal device, an indication indicating at least one of the following: the at least one beam having the most suitable signal level and/or quality; or the at least one of the plurality of beams being usable.

In an eleventh aspect, there is provided a second terminal device. The second terminal device comprises: transmitting circuitry configured to transmit, to a first terminal device, at least one reference signal associated with at least one of a plurality of beams; monitoring circuitry configured to monitor, from the first terminal device, an indication indicating at least one of the following: at least one beam having most suitable signal level and/or quality among the plurality of beams; or the at least one of the plurality of beams being usable; and determining circuitry configured to determine, based on the monitoring, one or more of the at least one of a plurality of beams for signal transmission.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example system in which embodiments of the present disclosure may be implemented;

FIG. 1B illustrates an example of a sidelink slot configuration comprising PSFCH resources for HARQ feedback;

FIG. 1C illustrates an example of Uu beam alignment procedure;

FIG. 1D illustrates an example of a possible sidelink initial beam alignment procedure;

FIG. 1E illustrates some examples of transmit beams at UE A and receive beams at UE B for a sidelink communication;

FIG. 1F illustrates a schematic diagram illustrating transmit beam training and the corresponding beam reporting using PSFCH according to some schemes;

FIG. 2 illustrates a flowchart illustrating a process for beam reporting according to some embodiments of the present disclosure;

FIG. 3 illustrates a schematic diagram illustrating transmit beam training and enhanced beam reporting using PSFCH according to some embodiments of the present disclosure;

FIG. 4 illustrates a schematic diagram illustrating transmit beam training and enhanced beam reporting using PSFCH according to some other embodiments of the present disclosure;

FIG. 5 illustrates a flowchart of operations of beam reporting at an Rx UE according to some embodiments of the present disclosure;

FIG. 6 illustrates a flowchart of a method implemented at a first terminal device according to some embodiments of the present disclosure;

FIG. 7 illustrates a flowchart of a method implemented at a second terminal device according to some embodiments of the present disclosure;

FIG. 8 illustrates a simplified block diagram of an apparatus that is suitable for implementing embodiments of the present disclosure; and

FIG. 9 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In some embodiments of the present disclosure, a scheme related to fast beam reporting for beam training in FR2 sidelink communication is proposed. Principle and embodiments of the present disclosure will be described in detail below with reference to the accompanying drawings.

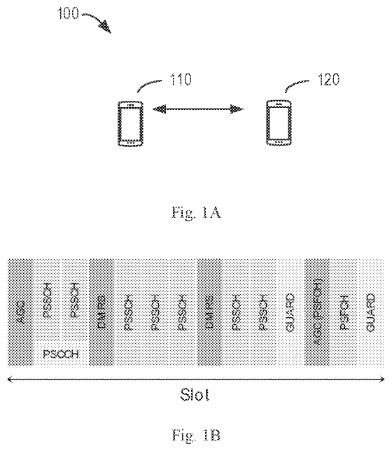

Reference is first made to FIG. 1A, which illustrates an example system 100 in which embodiments of the present disclosure may be implemented. The system 100 includes a plurality of terminal devices, such as a first terminal device 110 and a second terminal device 120. The first terminal device 110 and the second terminal device 120 may perform a sidelink communication with each other, and there may be transmit beam training procedure for the sidelink communication. In some examples, the second terminal device 120 may be a terminal device for transmitting a reference signal, e.g. a Tx (transmit) UE. The first terminal device 110 may be a terminal device for receiving the reference signal, e.g. a Rx (receive) UE. In some examples, the first terminal device 110 may send a feedback for the reference signal to the second terminal device 120, for example, via a physical sidelink feedback channel (PSFCH) resource.

It is to be understood that the number of terminal devices is only for the purpose of illustration without suggesting any limitations. The system 100 may include any suitable number of terminal devices adapted for implementing embodiments of the present disclosure. Although not shown, it would be appreciated that the system 100 may also include one or more network devices.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In order to make the description of the scheme of the embodiments of the present disclosure more clear, the related technologies are first introduced below. In Rel-16 (the work item “5G V2X with NR sidelink”), PSFCH (physical sidelink feedback channel) for sidelink communication was specified to carry HARQ (hybrid automatic repeat request) feedback over the sidelink (at physical layer) from a UE which is an intended recipient of a PSCCH/PSSCH transmission (henceforth a receiver UE) to the UE which performed the transmission (henceforth a transmitter UE). PSFCH transmits a sequence in one PRB repeated over two OFDM symbols (the first of which can be used for AGC) near the end of the sidelink resource in a slot. The time resources for PSFCH are (pre-)configured to occur once in every 1, 2, or 4 slots. The HARQ feedback resource (PSFCH) is derived from the resource location of PSCCH/PSSCH. FIG. 1B illustrates an example of a sidelink slot configuration comprising PSFCH resources for HARQ feedback. As shown in FIG. 1B, an example of a slot format of PSCCH, PSSCH, and PSFCH is provided. The base sequence is (pre-)configured per sidelink resource pool.

FIG. 1C illustrates an example of Uu beam alignment procedure. Uu beam management is defined in three phases as described in 3GPP TS 38.214 section 5.1.5 (TCI and QCL framework) and section 5.1.6 (CSI-RS reception procedures). As shown in FIG. 1C, the procedure 100-1 comprises Phase #1 (P1), Phase #2 (P2) and Phase #3 (P3). During the phase #1 (P1), as shown at 101, a UE 130 uses a broad Rx (receive) beam while a gNB 140 is performing SS burst where SSBs are swept and transmitted in different angular directions covering the cell. Refer to steps 103, 105, 107 and 109, the UE 130 measures RSRP (reference signal received power) for all SSB beams on all UE panels and sends PRACH on the RACH Occasion associated to the best SSB beam to connect to the network with the reciprocal transmit (Tx) beam of the best SSB beam. During the phase #2 (P2), as shown at 111, the UE 130 uses a broad Rx beam (receive beam) to receive gNB refined DL CSI-RS beam sweeping within the connected SSB beam. The UE 130 measures RSRP for all CSI-RS beams and reports best beam ID(s) back to the gNB 140 still using the reciprocal broad Tx beam (transmit beam). During the phase #3 (P3), as shown at 113, the gNB 140 transmits a repeated CSI-reference signal with the selected beam based on the UE reporting in the phase #2 and the UE 130 sweeps refined Rx beam settings to identify its best narrow Rx beam. At the end of the P3, as shown at 115, alignment between gNB Tx beam and UE Rx beam is obtained for maximized directional gain.

FIG. 1D illustrates an example of a possible sidelink initial beam alignment procedure (inspired from Uu initial beam alignment). As the standardization objective states, sidelink operation in FR2, will be a CSI-RS based procedure and attempt to reuse as much as possible of the Uu beam alignment procedure. The most straight forward sidelink beam alignment inspired by the Uu interface was protected and shown in FIG. 1D.

In the procedure 100-2, in a discovery procedure as shown at 102, e.g. following prose and discovery model A or B. For the case of V2x, the discovery occurs at the V2x layer and is enabled by the exchange of CAMs in the ITS band at 5.9 GHz. It should be noted that the discovery procedure can occur in either FR1 or FR2. However, the benefit of doing this in FR1 is the absence of the need to perform beam-based discovery. If applied at FR2 then it will need to be performed with only wide beams, so discovery can be limited in coverage and take a long time for devices only capable of transmitting from a single panel at the time (current smartphone UE implementation). At 104, a P-UE (primary UE) 160 and a S-UE (secondary UE) 150 establish a unicast link via PC5 connection establishment. It should be noted that this can either be performed at FR1 or FR2. At 106, the P-UE 160 or the S-UE 150 triggers the initial beam alignment. It should be noted that this trigger can occur at either FR1 or FR2, and can indicate configuration details on the beam alignment (e.g. SL (sidelink) beam management reference signals (SL-BMRS) format to be used, number of expected beam sweeps, the time period where the beam sweeps are expected etc.). As shown at 108, the P-UE 160 performs the wide SL-BMRS beam sweep. This step is dedicated to FR2. The slot format used to transmit these SL-BMRS for the purpose of beam sweeping is still open. However, in some embodiment of the present disclosure, it may be assumed that each individual SL-BMRS is transmitted in a single SL slot. Therefore, if four wide beam sweeps are required, then the P-UE 160 will have to transmit 4 distinct SL slots, and each with a different beam applied. At 110a, the S-UE 150 reports to the P-UE 160 what was the best wide SL-BMRS beam (e.g. the index or slot of the SL-BMRS beam received with the higher power. This report can be transmitted in FR1 or FR2, and this corresponds to the completion of P1. As shown at 112, the P-UE 160 performs the marrow SL-BMRS beam sweep. This step is dedicated to FR2. As in 108, here it is assumed that this sweep will utilize a single SL slot per beam sweep. At 114, the S-UE 150 reports to the P-UE 160 what was the best narrow SL-BMRS beam. This report can be transmitted in FR1 or FR2, and this corresponds to the completion of P2. At 116, the P-UE 160 performs m repetitions of the SL-BMRS while applying the selected narrow Tx beam. The S-UE 150 performs a narrow Rx beam sweep with the purpose of identifying the best narrow Rx beam.

Beam reporting is critical for many stages of SL FR2 beam management such as initial beam pairing and beam maintenance. As for beam reporting, the following agreement was made in RAN1 #112bis: the container(s) of sidelink beam reporting for beam maintenance is at least selected from the following options: Option 1: SL PHY layer signal (e.g., PSFCH, SCI); Option 2: SL MAC CE. FFS is PC5-RRC, signaling over Uu link (e.g., UCI). As seen in the above agreement, PSFCH was identified as an option as a container of sidelink beam reporting. PSFCH is promising in standardization since it is fast and resource efficient to provide beam report as an SL PHY layer signal. In some schemes, it is proposed that using PSFCH to acknowledge whether a transmit beam is acceptable or not. With reference FIG. 1E and FIG. 1F, FIG. 1E illustrates some examples of transmit beams at UE A and receive beams at UE B for a sidelink communication. As shown in FIG. 1E, the transmit beams (a1, a2, a3, a4) are employed at UE A, and the receive beams (b1, b2, b3, b4) are employed at UE B. The UE A transmits RSs (reference signals) in different directions (using different transmit beams: a1, a2, a3, a4). FIG. 1F illustrates a schematic diagram illustrating transmit beam training and the corresponding beam reporting using PSFCH according to some schemes. With some beam reporting schemes above, the Tx UE only knows which transmit beams are suitable but doesn't know which transmit beam is best.

A Tx UE transmits RSs (reference signal) via different transmit beams to an Rx UE, and the Rx UE measures RSs and then reports measured beam information to the Tx UE so that the Tx UE would employ a suitable transmit beam for sidelink communication with the Rx UE. The following agreements mentioning beam reporting were made in RAN1 #112bis: RAN1 can study the following candidate procedure where initial beam pairing is performed before sidelink unicast link establishment, including at least the following steps and how to determine UE2: UE1 sends reference signals via different transmit beams (It is noted that multiple reference signals transmissions (e.g. repetitions) from each of the beams can be studied. FFS: reference signals are sent, and applicable reference signal); the UE2 measures the reference signals and determines a UE1 transmit beam and/or a UE2 receive beam (FFS: whether/how to determine a UE2 transmit beam); the UE2 indicates to the UE1 the determined the UE1 transmit beam (FFS: how to indicate the determined transmit beam, including its feasibility); the UE1 and the UE2 set up sidelink unicast link using the determined beam, following conventional link establishment procedure.

RAN1 can study the following candidate procedure where initial beam pairing starts after sidelink unicast link establishment between the UE1 and the UE2, including studying whether and in which cases initial beam pairing after sidelink unicast link establishment is feasible. The UE1 and the UE2 set up sidelink unicast link, following conventional link establishment procedure (FFS: the beams used for unicast link establishment). The UE1 and/or the UE2 configure the resources for beam sweeping and/or beam reporting (FFS: details of resources configuration). The UE1 and/or the UE2 use the configured resources to transmit reference signals and determine a pair of transmit beam and receive beam based on beam sweeping (FFS: applicable reference signal(s), and whether/how to indicate the determined beams between the UE1 and the UE2, and difference between initial beam pairing (after sidelink unicast link establishment) and beam maintenance.

Resource efficient and fast beam reporting is desired to achieve proper and prompt beam management. In the scheme of the embodiments of the present disclosure, an enhancement to fast beam reporting using PSFCH for sidelink communication in FR2 are designed. In some embodiments, a scheme proposed in the present disclosure, for example, a scheme of fast beam reporting via PSFCH for transmit beam training in FR2 sidelink communication, may comprise a key idea that, in a beam training procedure, in the PSFCH resource associated with an RS signal transmitted from a Tx UE employing a transmit beam, a Rx UE transmits a PSFCH conveying an ACK to indicate the transmit beam is acceptable (or called usable herein) and is the best beam so far, or transmits a PSFCH conveying a NACK to indicate the transmit beam is acceptable but isn't the best beam so far, or doesn't transmit (PSFCH absence) to indicate the transmit beam isn't acceptable. Accordingly, based on the collected information, such as the best transmit beam so far, the acceptable transmit beam(s), and the measured PSFCH received powers, the Tx UE may select a set of suitable transmit beams. The proposed scheme in the present disclosure can enable fast transmit beam training for sidelink communication in FR2 with little impact to specification. The schemes proposed in the present disclosure will be further describe in the following embodiments.

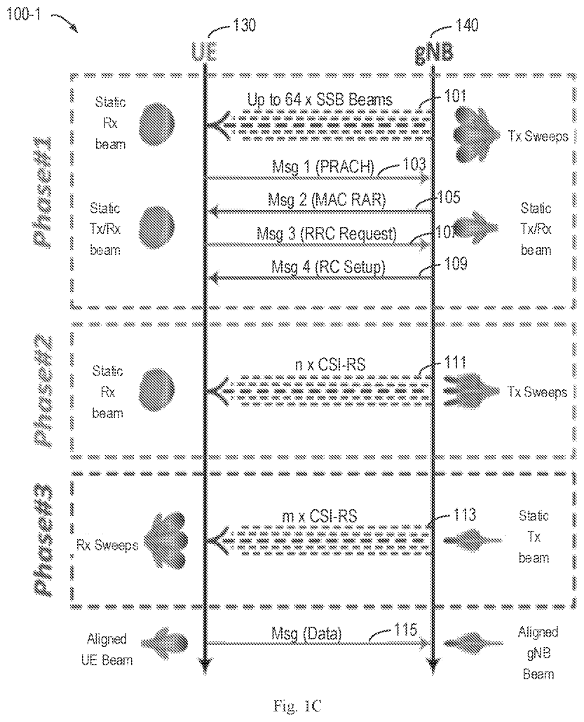

Reference is now made to FIG. 2, which shows a process 200 for beam reporting according to some embodiments of the present disclosure. The process 200 may involve the first terminal device 110 and the second device 120 as illustrated in FIG. 1A. It would be appreciated that although the process 200 for beam reporting has been described in the system 100 of FIG. 1A, this process may be likewise applied to other communication scenarios. In some examples, the first terminal device 110 may be the Rx UE, and the second terminal device 120 may be the Tx UE.

In the process 200, the second terminal device 120 may transmit (202), to the first terminal device 110, at least one reference signal 205 associated with at least one of a plurality of beams. On the first terminal device 110 side, after receiving (204) the at least one reference signal 205 associated with the at least one of the plurality of beams, the first terminal device 110 may determine (206) usability of the at least one of the plurality of beams associated with the at least one reference signal 205 transmitted by the second terminal device 120 based on measured signal level and/or quality. In some examples, a measured signal level and/or quality may be measured for a reference signal (RS) transmitted with a transmit beam.

In some examples, the signal level and/or quality may be a reference signal received power (RSRP). In order to determine the usability of the at least one of the plurality of beams, the first terminal device 110 may measure signal level and/or quality of the plurality of beams, and based on the at least one of the plurality of beams having the signal level and/or quality above a threshold, determine that the at least one of the plurality of beams is usable. For example, if a beam has a RSRP above a threshold, then the first terminal device 110 may determine that this beam is usable (or acceptable). In some examples, a signal level and/or quality of a beam may refer to a signal level and/or quality measured for a reference signal transmitted with this beam, for example, a RSRP of a beam may refer to a RSRP of a RS transmitted with this beam.

The first terminal device 110 may carry out (208) beam-wise comparison among the at least one of the plurality of the beams determined usable. The beam-wise comparison may be based on the measured signal level and/or quality for identifying at least one beam having most suitable signal level and/or quality for signal transmission. For the purpose of identifying the at least one beam having the most suitable signal level and/or quality for the signal transmission, the first terminal device 110 may store the measured signal level and/or quality, additionally or alternatively, the determined usability, so as to use the one of both of them for identifying the at least one beam having the most suitable signal level and/or quality for the signal transmission. For example, the first terminal device 110 may store the measured RSRPs of the plurality of beams. The first terminal device 110 may also store the usability of the plurality of beams, for example, whether a beam is usable (or acceptable).

In order to carry out the beam-wise comparison for identifying the at least one beam, the first terminal device 110 may, based on signal level and/or quality of the at least one beam is larger than signal level and/or quality of other beams among the plurality of beams, determine that the at least one beam has the most suitable signal level and/or quality for the signal transmission. For example, based on a RSRP of beam is larger than a recorded largest RSRP, the first terminal device 110 may determine that the beam has the most suitable RSRP for the signal transmission.

In some embodiments, the first terminal device 110 may record the at least one transmit beam having the most suitable signal level and/or quality for the signal transmission as at least one best transmit beam, additionally or alternatively, record at least one receive beam associated with the most suitable signal level and/or quality as at least one best receive beam.

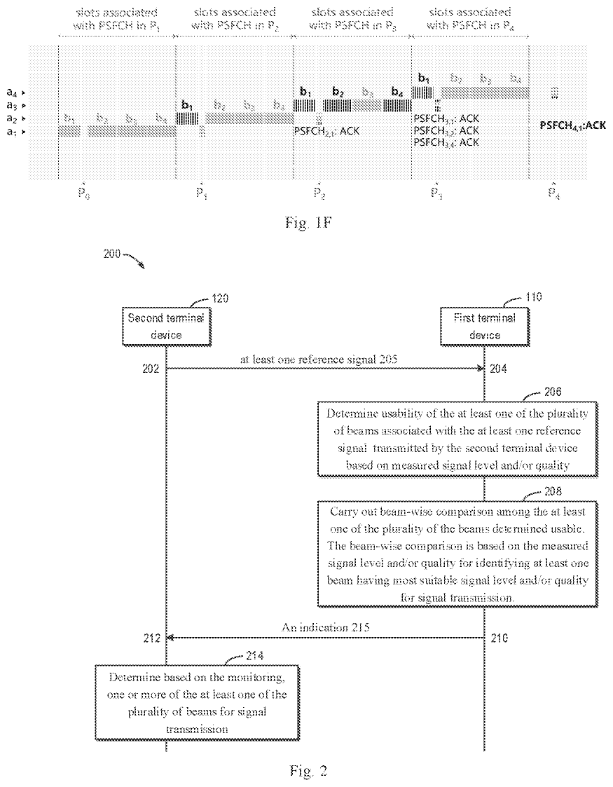

The beam mentioned in FIG. 2 may be transmit beam(s). For example, the at least one beam may be at least one transmit beam, and the plurality of beams may be a plurality of transmit beams. In some other embodiments, in order to carry out the beam-wise comparison for identifying the at least one beam, the first terminal device 110 may determine that the at least one transmit beam has the most suitable signal level and/or quality for the signal transmission based on the following condition: a pattern of transmit beam sweeping indicates that the at least one transmit beam is recorded as at least one best transmit beam but at least one receive beam corresponding to the at least one transmit beam is not recorded as at least one best receive beam. The examples for these embodiments may further refer to FIG. 4.

Then the first terminal device 110 may transmit (210), to the second terminal device 120, an indication 215 indicating the at least one beam having the most suitable signal level and/or quality, additionally or alternatively, indicating the at least one of the plurality of beams being usable. In some examples, the first terminal device 110 may transmit, on a physical sidelink feedback channel resource being for at least one reference signal transmission using the at least one beam, an acknowledgement (ACK) indicating the at least one beam being usable and having the most suitable signal level and/or quality for the signal transmission. In some other examples, the first terminal device 110 may transmit, on a physical sidelink feedback channel resource being for at least one reference signal transmission using the at least one of the plurality of beams, a non-acknowledgement (NACK) indicating that the at least one of the plurality of beams is usable and does not have the most suitable signal level and/or quality for the signal transmission. In some further examples, based on the at least one of the plurality of beams is not usable, the first terminal device 110 may prevent from transmitting on the physical sidelink feedback channel resource being for at least one reference signal transmission using the at least one of the plurality of beams. For example, if a beam is not usable, then the first terminal device 110 may transmit neither an ACK nor a NACK.

For the indication 215 transmitted by the first terminal device 110, on the second terminal device 120 side, the second terminal device 120 may receive (212) the indication 215. In some examples, in order to receive the indication 215, the second terminal device 120 may monitor, from the first terminal device 110, the indication 215. In some examples, based on receiving, on a physical sidelink feedback channel resource being for reference signal transmission using the at least one beam, an acknowledgement, the second terminal device 120 may determine that the at least one beam being usable and having the most suitable signal level and/or quality for the signal transmission. In some other examples, based on receiving, on a physical sidelink feedback channel resource being for reference signal transmission using the at least one of the plurality of beams, a non-acknowledgement, the second terminal device 120 may determine that at least one of the plurality of beams is usable and does not have the most suitable signal level and/or quality for the signal transmission. In some further examples, based on receiving, on a physical sidelink feedback channel resource being for reference signal transmission using the at least one of the plurality of beams, neither an acknowledgement nor a non-acknowledgement, the second terminal device 120 may determine that the at least one of the plurality of beams is not usable.

The second terminal device 120 may determine (214), based on the monitoring, one or more of the at least one of the plurality of beams for signal transmission. In some examples, the second terminal device 120 may measure at least one received power of physical sidelink feedback channel associated with the at least one of the plurality of the beams being usable, the received power of physical sidelink feedback channel being for conveying the indication, and then determine an absolute difference or a relative difference between at least one received power of physical sidelink feedback channel associated with the at least one of the plurality of the beams being usable and at least one received power of physical sidelink feedback channel associated with the at least one beam having the most suitable signal level and/or quality.

Further, the second terminal device 120 may determine, based on the absolute difference or the relative difference, the one or more of the at least one of the plurality of beams for signal transmission. For example, based on the collected information, such as the best transmit beam so far (an example of a beam having the most suitable signal level and/or quality), the acceptable transmit beam(s) (an example of beam(s) being usable), and the measured PSFCH received powers (i.e. an example of a received power of physical sidelink feedback channel associated with a beam), the second terminal device 120 may select a set of suitable transmit beams for signal transmission. In some examples, the second terminal device 120 may determine an acceptable transmit beam as a suitable beam if the difference between the received power (Pᵢ) of the PSFCH acknowledging the acceptable transmit beam and the receive power (Pₒ) of the PSFCH acknowledging the best transmit beam so far is less than a (pre-)configured power difference threshold. The details may further refer to the embodiments below.

It is noted that in the embodiments of the present disclosure, one terminal device as the second terminal device 120 transmits one reference signal using one beam, correspondingly, one terminal device as the first terminal device 110 transmits the indication 215 on one feedback resource associated with the one reference signal 205. For example, one Tx UE transmits one reference signal 205 using one beam, and one Rx UE transmits the indication 215 on one feedback resource associated with the one reference signal. The indication 215 indicates the quality of the one beam. The feedback resource may be the physical sidelink feedback channel (PSFCH) resource.

With reference to some embodiments above, a Tx UE may be as an example of a second terminal device 120, and a Rx UE may be as an example of a first terminal device 110. In some examples, in the PSFCH resource associated with an RS signal transmitted from a Tx UE employing a transmit beam, a Rx UE transmits a PSFCH conveying an ACK to indicate the transmit beam is acceptable and is the best beam so far, or transmits a PSFCH conveying a NACK to indicate the transmit beam is acceptable but isn't the best beam so far, or doesn't transmit (PSFCH absence) to indicate the transmit beam isn't acceptable. In some other examples, based on the transmit beam sweeping pattern, if the transmit beam is the best beam so far but the receive beam is not the best beam, the Rx UE may transmit a PSFCH conveying ACK to provide diversity of PSFCH transmissions conveying ACKs to increase the chance for the Tx UE to detect a PSFCH conveying ACK. The Rx UE may transmit the PSFCH via the recorded best receive beam to increase link level performance of the PSFCH transmission. Accordingly, based on the collected information: the best transmit beam so far, the acceptable transmit beam(s), and the measured PSFCH received powers, the Tx UE selects a set of suitable transmit beams. The Tx UE may determine an acceptable transmit beam as a suitable beam if the difference between the received power (Pᵢ) of the PSFCH acknowledging the acceptable transmit beam and the receive power (Pₒ) of the PSFCH acknowledging the best transmit beam so far is less than a (pre-)configured power difference threshold.

Some embodiments of detailed operations at Tx UE and Rx UE are described as follows. Operations at the Rx UE (e.g., UE B in FIG. 1E) in the transmit beam training procedure will be described first.

With a receive beam (beam bⱼ), the Rx UE measures RSRP of an RS transmitted from the Tx UE (e.g., UE A) employing a transmit beam (beam aᵢ). If the RSRP of the RS is above a threshold which may be configured (or pre-configured), the Rx UE may identify or record the transmit beam (aᵢ) as acceptable. A transmit beam is acceptable refers to the transmit beam being usable for signal transmission, that is an acceptable beam may be referred to as a usable beam.

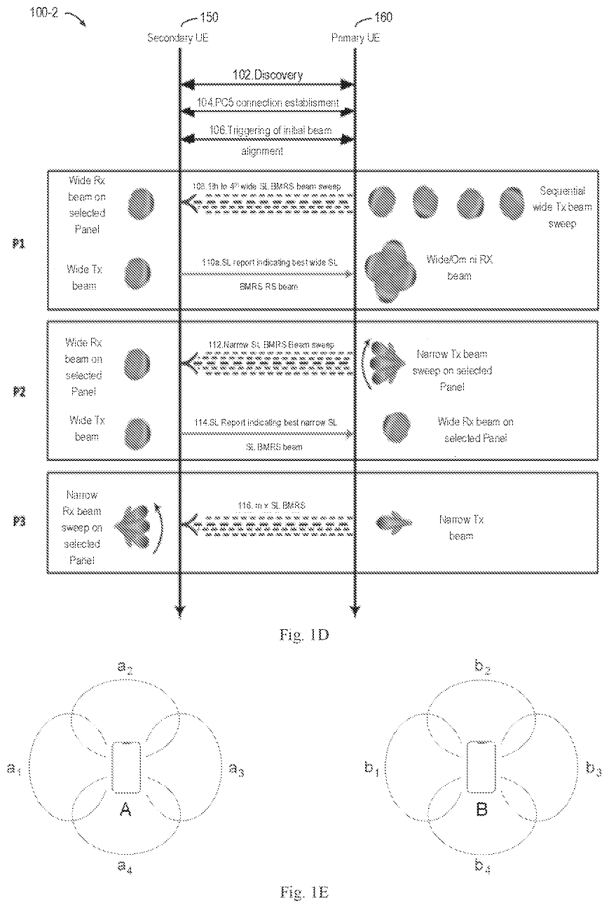

Then the Rx UE may check whether the acceptable transmit beam (aᵢ) is the best transmit beam so far. Specifically, if the transmit beam is the first beam recorded as acceptable beam in the transmit beam training procedure, the Rx UE may identify or record the transmit beam as the best transmit beam so far (aₒ) and records the RSRP of the RS as the largest RSRP (RSRPₘ). Based on the case above, in some embodiments, the Rx UE may record the receive beam as the best receive beam (bₒ). With reference to FIG. 1E and FIG. 3 or FIG. 4, a RS is transmitted with a transmit beam a₂ and received with a receive beam b₁. In FIG. 3 and FIG. 4, the transmit beams represented by the stripe pattern represent acceptable transmit beams, and other transmit beams represented by grey represents unacceptable transmit beams. It can be seen that the transmit beam a₂ is a first acceptable transmit beam, so the Rx UE may identify or record the transmit beam a₂ as the best transmit beam so far (aₒ) and records the RSRP of the RS as the largest RSRP (RSRPₘ). Furthermore, the Rx UE may transmit a PSFCH conveying acknowledgement (ACK), as shown at PSFCH_{2,1}: ACK in FIG. 3 or FIG. 4.

If the transmit beam is not the first beam recorded as acceptable beam in the transmit beam training procedure, the Rx UE may compare the RSRP with the recorded largest RSRP. If the RSRP is larger than the recorded largest RSRP, the Rx UE may identify or record the transmit beam as the best transmit beam so far (aₒ) and record the RSRP as the largest RSRP (RSRPₘ). In this case, in some embodiments, the Rx UE may record the receive beam as the best receive beam (b). An example may be described with reference to FIG. 1E, as shown in FIG. 1E, for example, a RS is transmitted with a transmit beam a₃ and received with a receive beam b₁, and the RSRP of the RS is larger than the recorded largest RSRP, then the RSRP of this RS will be recorded as a new largest RSRP. In this case, in some examples, the transmit beam a₃ may be recorded as the best transmit beam so far aₒ, additionally or alternatively, the receive beam b₁ may be recorded as the best receive beam bₒ.

In some embodiments, in the PSFCH resource associated with the RS signal, if the transmit beam (aᵢ) is acceptable and is the best transmit beam so far (aᵢ=aₒ), and if the corresponding receive beam is the best receive beam (bⱼ=bₒ), the Rx UE may transmit a PSFCH conveying acknowledgement (ACK). In some examples, if a correspondence of the Tx beam and the Rx beam is assumed, the Rx UE may transmit the PSFCH via the beam bⱼ. With reference to FIG. 1E and FIG. 3, for example, when a RS is transmitted with a transmit beam a₃ and received with a receive beam b₁, the RSRP of the RS is recorded as the largest RSRP, and the transmit beam a₃ is recorded as the best transmit beam so far aₒ, and the receive beam b₁ is recorded as the best receive beam bₒ, in this case the Rx UE may transmit the PSFCH conveying an ACK (see PSFCH_{3,1}: ACK shown in FIG. 3). As shown in FIG. 3, after the transmit beam training procedure ends, the Rx UE identifies a₃ as the best transmit beam according to PSFCH_{3,1}(ACK), a₂ and a₄ as acceptable transmit beams.

In some embodiments, if the transmit beam (aᵢ) is acceptable and is the best transmit beam so far (aᵢ=aₒ), and if the corresponding receive beam is not the best receive beam (bⱼ≠bₒ), the Rx UE may transmit a PSFCH conveying NACK. With reference to FIG. 1E and FIG. 3, when another RS is transmitted with a transmit beam a₃ and received with a receive beam b₂. As mentioned above, the transmit beam a₃ is recorded as the best transmit beam so far aₒ, but the receive beam b₂ is not identified or recorded as the best receive beam bₒ, in this case the Rx UE may transmit the PSFCH conveying a NACK (see PSFCH_{3,2}: NACK shown in FIG. 3).

In some other embodiments, if the transmit beam (aᵢ) is acceptable and is the best transmit beam so far (aᵢ=aₒ), and if the corresponding receive beam is not the best receive beam (bⱼ≠bₒ), and if the Tx UE only needs to know the best transmit beam, even if the receive beam is not identified or recorded as the best receive beam, the Rx UE may transmit a PSFCH conveying ACK. This would provide diversity of PSFCH transmissions conveying ACKs to increase the chance for the Tx UE to detect a PSFCH conveying ACK. If Tx/Rx beam correspondence is assumed, the Rx UE may transmit the PSFCH via bⱼ. Alternatively, the Rx UE may transmit the PSFCH via bₒ. This would increase link level performance of the PSFCH transmission. In these embodiments, the transmit beam (aᵢ) is the best transmit beam so far (aᵢ=aₒ) can be determined based on the transmit beam sweeping pattern known to the Rx UE or detected at the Rx UE. The transmit beam-sweeping pattern may indicate: via which transmit beam the RS signal is transmitted, or whether the two RS signals are transmitted via the same transmit beam. For example, with reference to FIG. 1E and FIG. 4, when a RS is transmitted with a transmit beam a₃ and received with a receive beam b₁, the RSRP of the RS is recorded as the largest RSRP, and the transmit beam a₃ is recorded as the best transmit beam so far aₒ, and the receive beam b₁ is recorded as the best receive beam bₒ, The Rx UE may transmit the PSFCH conveying an ACK (see PSFCH_{3,1}: ACK shown in FIG. 4). When a further RS is transmitted with a transmit beam a₃ and received with a receive beam b₂. As mentioned above, the transmit beam a₃ is recorded as the best transmit beam so far aₒ, but the receive beam b₂ is not recorded as the best receive beam bₒ. In this case, based on the transmit beam-sweeping pattern, the Rx UE may know that the further RS above is transmitted with the best transmit beam so far, or know that the further RS above is transmitted with the same transmit beam as a transmit beam for transmitting the RS above, then, the Rx UE may transmit a PSFCH conveying an ACK (see PSFCH_{3,2}: ACK shown in FIG. 4). Similarly, PSFCH 3,4 conveys an ACK. The Rx UE may transmit PSFCH_{3,2} and PSFCH_{3,4} via bₒ(b₁). After the transmit beam training procedure ends, the UE A identifies a₃ as the best transmit beam according to PSFCH_{3,1}(ACK), and a₂ and a₄ as acceptable transmit beams.

In some embodiments, if the transmit beam (aᵢ) is acceptable and is not the best transmit beam so far (aᵢ≠aₒ), the Rx UE may transmit a PSFCH conveying NACK. With continued reference to FIG. 1E and FIG. 3 or FIG. 4, when a RS is transmitted with a transmit beam a₄ and received with a receive beam b₁, the transmit beam a₄ is acceptable and is not recorded the best transmit beam so far, in this case the Rx UE may transmit the PSFCH conveying a NACK (see PSFCH_{4,1}: NACK shown in FIG. 3 or FIG. 4). In some examples, if the correspondence of the Tx beam and the Rx beam is assumed, the Rx UE may transmit the PSFCH via bⱼ.

In some embodiments, if the transmit beam (aᵢ) is not acceptable, then the Rx UE doesn't transmit the PSFCH. With continued reference to FIG. 1E and FIG. 3 or FIG. 4, for example, when a RS is transmitted with a transmit beam aᵢ and received with a receive beam b₁, the RSRP of the RS is not above the threshold, thus the transmit beam aᵢ is not acceptable (i.e. unusable), in this case, the Rx UE will not transmit any PSFCH.

In FIG. 3 and FIG. 4 above, due to a delay, the indication indicating the transmit beam is acceptable and is the best beam so far, or is acceptable but isn't the best beam so far, or isn't acceptable may be in the next set of slots. For example, the transmit beam a₂ is acceptable and is the best transmit beam in P1 may be indicated at P2, as shown at P2, i.e. PSFCH_{2,1}: ACK.

Operations at the Tx UE (e.g., UE A in FIG. 1E) in the transmit beam training procedure will be described below.

The Tx UE may transmit a RS by employing a transmit beam (beam aᵢ). In the PSFCH resource associated with the RS signal, the Tx UE may try to detect a PSFCH transmitted from the Rx UE. If the correspondence of the Tx beam and the Rx beam is assumed, the Tx UE may employ the beam aᵢ as the beam for PSFCH detection (reception). In some examples, if an ACK is detected, the Tx UE may identify or record that the transmit beam is acceptable and is the best beam so far. In some examples, if a NACK is detected, the Tx UE may identify or record that the transmit beam is acceptable and isn't the best beam so far. In some examples, if no PSFCH is detected, the Tx UE may identify or record that the transmit beam is not acceptable.

In some embodiments, the Tx UE may measure or record the received power of the PSFCH. Based on the recorded information, such as the best transmit beam so far, the acceptable transmit beam(s), and the PSFCH received powers, the Tx UE may select a set of suitable transmit beams. Specifically, in some embodiments, the Tx UE may determine an acceptable transmit beam as a suitable beam if the difference between the received power (Pᵢ) of the PSFCH acknowledging the acceptable transmit beam and the receive power (Pₒ) of the PSFCH acknowledging the best transmit beam so far is less than a (pre-)configured power difference threshold. In some other embodiments, the relative difference can be used for the Tx UE to select a set of suitable transmit beams. For example, the relative difference may be |Pᵢ−Pₒ|/Pₒ, and if |Pᵢ−Pₒ|/Pₒ≤γ (γ is a (pre-)configured threshold), the Tx UE may determine an acceptable transmit beam as a suitable beam. The step above can be carried out after the transmit beam training procedure ends or in the middle of the transmit beam training procedure.

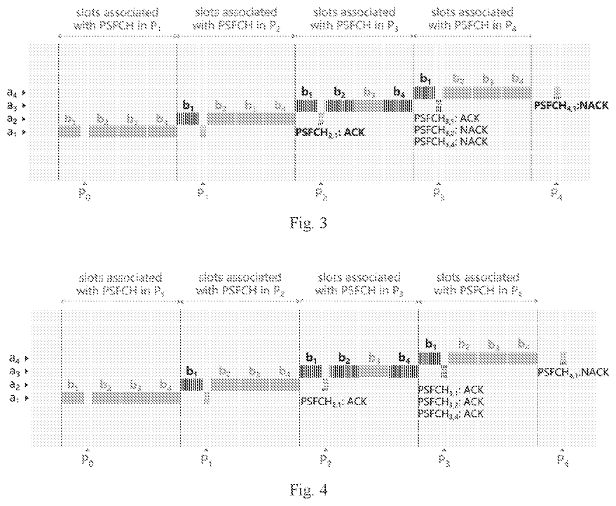

FIG. 5 illustrates a flowchart of operations of beam reporting at a Rx UE according to some embodiments of the present disclosure. As shown in FIG. 5, in a process 500, in step 501, a transmit beam training starts. In step 503, with a receive beam (bⱼ), the Rx UE may measure RSRP of a RS transmitted via a transmit beam (aᵢ). In step 505, the Rx UE determine whether the RSRP is larger than a (pre-)configured threshold. If yes, step 507 is performed, and if no, step 503 is continued to be performed. In step 507, the Rx UE identify or record the transmit beam (aᵢ) as acceptable. In step 509, the Rx UE determine whether the transmit beam is the first beam recorded as acceptable. If yes, step 513 is performed, and if no, step 511 is performed. In step 511, the Rx UE determine whether RSRP is larger than RSRPₘ (recorded largest RSRP). If yes, step 513 is performed, and if no, step 515 is performed. In step 513, the Rx UE may identify the transmit beam as the best transmit beam so far (aₒ) and record the RSRP as RSRPₘ. After 513, step 521 is performed. In step 521, the Rx UE may record the receive beam (bⱼ) as the best receive beam (bₒ). In step 523, the Rx UE may transmit PSFCH conveying ACK, via bⱼ. In step 515, the Rx UE may determine whether aᵢ=aₒ. If yes, step 517 is performed, and if no, step 519 is performed. In step 517, the Rx UE may transmit PSFCH with NACK or ACK, via bⱼ or via bₒ. In step 519, the Rx UE may transmit PSFCH with NACK, via bⱼ.

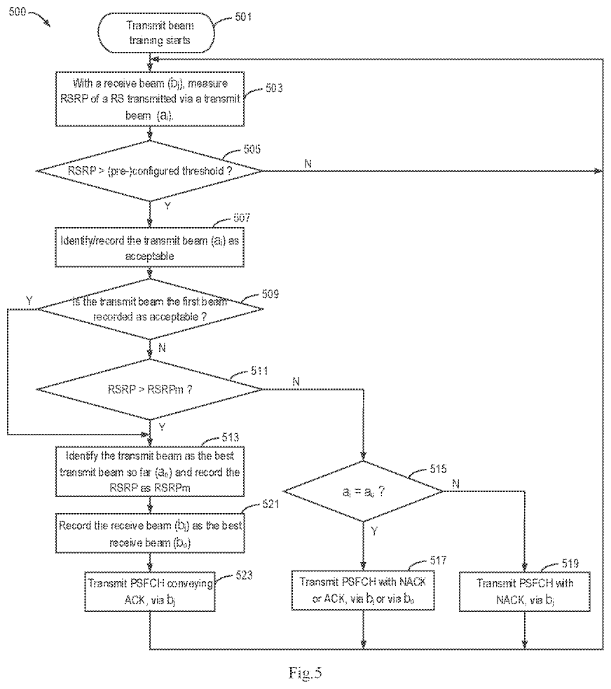

FIG. 6 illustrates a flowchart of a method implemented at a first terminal device 110 according to some embodiments of the present disclosure. In the method 600, at block 610, the first terminal device 110 may determine usability of at least one of a plurality of beams associated with at least one reference signal transmitted by a second terminal device 120 based on measured signal level and/or quality. At block 620, the first terminal device 110 may carry out beam-wise comparison among the at least one of the plurality of the beams determined usable, wherein the beam-wise comparison is based on the measured signal level and/or quality for identifying at least one beam having most suitable signal level and/or quality for signal transmission. At block 630, the first terminal device 110 may transmit, to the second terminal device 120, an indication indicating at least one of the following: the at least one beam having the most suitable signal level and/or quality; or the at least one of the plurality of beams being usable.

In some embodiments, in order to determine the usability of the at least one of the plurality of beams, the first terminal device 110 may measure signal level and/or quality of the plurality of beams, and based on the at least one of the plurality of beams having the signal level and/or quality above a threshold, determine that the at least one of the plurality of beams is usable.

In some embodiments, the first terminal device 110 may store the measured signal level and/or quality, or the determined usability, or both of them, for being used in identifying the at least one beam having the most suitable signal level and/or quality for the signal transmission.

In some embodiments, in order to carry out the beam-wise comparison for identifying the at least one beam, the first terminal device 110 may, based on signal level and/or quality of the at least one beam is larger than signal level and/or quality of other beams among the plurality of beams, determine that the at least one beam has the most suitable signal level and/or quality for the signal transmission.

In some embodiments, the at least one beam is at least one transmit beam. The first terminal device 110 may record the at least one transmit beam having the most suitable signal level and/or quality for the signal transmission as at least one best transmit beam, or record at least one receive beam associated with the most suitable signal level and/or quality as at least one best receive beam, or the combination thereof.

In some embodiments, the at least one beam is at least one transmit beam, and the plurality of beams are a plurality of transmit beams. In order to carry out the beam-wise comparison for identifying the at least one beam, the first terminal device 110 may determine that the at least one transmit beam has the most suitable signal level and/or quality for the signal transmission based on the following condition: a pattern of transmit beam sweeping indicates that the at least one transmit beam is recorded as at least one best transmit beam but at least one receive beam corresponding to the at least one transmit beam is not recorded as at least one best receive beam.

In some embodiments, in order to transmit the indication, the first terminal device 110 may transmit, on a physical sidelink feedback channel resource being for at least one reference signal transmission using the at least one beam, an acknowledgement indicating the at least one beam being usable and having the most suitable signal level and/or quality for the signal transmission.

In some embodiments, in order to transmit the indication, the first terminal device 110 transmitting, on a physical sidelink feedback channel resource being for at least one reference signal transmission using the at least one of the plurality of beams, a non-acknowledgement indicating that the at least one of the plurality of beams is usable and does not have the most suitable signal level and/or quality for the signal transmission.

In some embodiments, the first terminal device 110 may, based on the at least one of the plurality of beams is not usable, prevent from transmitting on a physical sidelink feedback channel resource being for at least one reference signal transmission using the at least one of the plurality of beams.

In some embodiments, the signal level and/or quality is a reference signal received power.

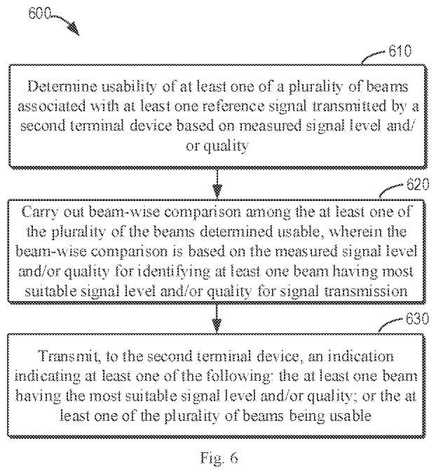

FIG. 7 illustrates a flowchart of a method implemented at a second terminal device 120 according to some embodiments of the present disclosure. In the method 700, at block 710, the second terminal device 120 may transmit, to the first terminal device 110, at least one reference signal associated with at least one of a plurality of beams. At block 720, the second terminal device 120 may monitor, from the first terminal device 110, an indication indicating at least one of the following: at least one beam having most suitable signal level and/or quality among the plurality of beams; or the at least one of the plurality of beams being usable. At block 730, the second terminal device 120 may determine, based on the monitoring, one or more of the at least one of a plurality of beams for signal transmission.

In some embodiments, the second terminal device 120 may, based on receiving, on a physical sidelink feedback channel resource being for reference signal transmission using the at least one beam, an acknowledgement, determining that the at least one beam being usable and having the most suitable signal level and/or quality for the signal transmission.

In some embodiments, the second terminal device 120 may, based on receiving, on a physical sidelink feedback channel resource being for reference signal transmission using the at least one of the plurality of beams, a non-acknowledgement, determining that at least one of the plurality of beams is usable and does not have the most suitable signal level and/or quality for the signal transmission.

In some embodiments, the second terminal device 120 may, based on receiving, on a physical sidelink feedback channel resource being for reference signal transmission using the at least one of the plurality of beams, neither an acknowledgement nor a non-acknowledgement, determine that the at least one of the plurality of beams is not usable.

In some embodiments, in order to determine the one or more of the at least one of the plurality of beams for signal transmission, the second terminal device 120 may measure at least one received power of physical sidelink feedback channel associated with the at least one of the plurality of the beams being usable, the received power of physical sidelink feedback channel being for conveying the indication, determine an absolute difference or a relative difference between at least one received power of physical sidelink feedback channel associated with the at least one of the plurality of the beams being usable and at least one received power of physical sidelink feedback channel associated with the at least one beam having the most suitable signal level and/or quality; and determine, based on the absolute difference or the relative difference, the one or more of the at least one of the plurality of beams for signal transmission.

In some embodiments, the signal level and/or quality may be a reference signal received power.

In some embodiments, an apparatus capable of performing any of the method 600 (for example, the first terminal device 110) may comprise means for performing the respective steps of the method 600. The means may be implemented in any suitable form. For example, the means may be implemented in a circuitry or software module.

In some embodiments, the apparatus comprises means for determining usability of at least one of a plurality of beams associated with at least one reference signal transmitted by a second terminal device 120 based on measured signal level and/or quality; means for carrying out beam-wise comparison among the at least one of the plurality of the beams determined usable, wherein the beam-wise comparison is based on the measured signal level and/or quality for identifying at least one beam having most suitable signal level and/or quality for signal transmission; and means for transmitting, to the second terminal device 120, an indication indicating at least one of the following: the at least one beam having the most suitable signal level and/or quality; or the at least one of the plurality of beams being usable.

In some embodiments, the means for determining the usability of the at least one of the plurality of beams comprises means for measuring signal level and/or quality of the plurality of beams; and means for, based on the at least one of the plurality of beams having the signal level and/or quality above a threshold, determining that the at least one of the plurality of beams is usable.

In some embodiments, the apparatus further comprises means for storing at least one of the following for being used in identifying the at least one beam having the most suitable signal level and/or quality for the signal transmission: the measured signal level and/or quality; or the determined usability.

In some embodiments, the means for carrying out the beam-wise comparison for identifying the at least one beam comprises means for, based on signal level and/or quality of the at least one beam is larger than signal level and/or quality of other beams among the plurality of beams, determining that the at least one beam has the most suitable signal level and/or quality for the signal transmission.

In some embodiments, the at least one beam is at least one transmit beam, and the apparatus further comprises means for recording the at least one transmit beam having the most suitable signal level and/or quality for the signal transmission as at least one best transmit beam; or means for recording at least one receive beam associated with the most suitable signal level and/or quality as at least one best receive beam.

In some embodiments, the at least one beam is at least one transmit beam, the plurality of beams are a plurality of transmit beams. The means for carrying out the beam-wise comparison for identifying the at least one beam comprises means for determining that the at least one transmit beam has the most suitable signal level and/or quality for the signal transmission based on the following condition: a pattern of transmit beam sweeping indicates that the at least one transmit beam is recorded as at least one best transmit beam but at least one receive beam corresponding to the at least one transmit beam is not recorded as at least one best receive beam.

In some embodiments, the means for transmitting the indication comprises means for transmitting, on a physical sidelink feedback channel resource being for at least one reference signal transmission using the at least one beam, an acknowledgement indicating the at least one beam being usable and having the most suitable signal level and/or quality for the signal transmission.

In some embodiments, the means for transmitting the indication comprises means for transmitting, on a physical sidelink feedback channel resource being for at least one reference signal transmission using the at least one of the plurality of beams, a non-acknowledgement indicating that the at least one of the plurality of beams is usable and does not have the most suitable signal level and/or quality for the signal transmission.

In some embodiments, the apparatus further comprises means for, based on the at least one of the plurality of beams is not usable, preventing from transmitting on a physical sidelink feedback channel resource being for at least one reference signal transmission using the at least one of the plurality of beams.

In some embodiments, the signal level and/or quality is a reference signal received power.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

In some embodiments, an apparatus capable of performing any of the method 700 (for example, the second terminal device 120) may comprise means for performing the respective steps of the method 700. The means may be implemented in any suitable form. For example, the means may be implemented in a circuitry or software module.

In some embodiments, the apparatus comprises means for transmitting, to a first terminal device 110, at least one reference signal associated with at least one of a plurality of beams; means for monitoring, from the first terminal device 110, an indication indicating at least one of the following: at least one beam having most suitable signal level and/or quality among the plurality of beams; or the at least one of the plurality of beams being usable; and means for determining, based on the monitoring, one or more of the at least one of a plurality of beams for signal transmission.

In some embodiments, the means for monitoring the indication comprises means for, based on receiving, on a physical sidelink feedback channel resource being for reference signal transmission using the at least one beam, an acknowledgement, determining that the at least one beam being usable and having the most suitable signal level and/or quality for the signal transmission.

In some embodiments, the means for monitoring the indication comprises means for, based on receiving, on a physical sidelink feedback channel resource being for reference signal transmission using the at least one of the plurality of beams, a non-acknowledgement, determining that at least one of the plurality of beams is usable and does not have the most suitable signal level and/or quality for the signal transmission.

In some embodiments, the apparatus further comprises means for, based on receiving, on a physical sidelink feedback channel resource being for reference signal transmission using the at least one of the plurality of beams, neither an acknowledgement nor a non-acknowledgement, determine that the at least one of the plurality of beams is not usable.

In some embodiments, the means for determining the one or more of the at least one of the plurality of beams for signal transmission comprises means for measuring at least one received power of physical sidelink feedback channel associated with the at least one of the plurality of the beams being usable, the received power of physical sidelink feedback channel being for conveying the indication; means for determining an absolute difference or a relative difference between at least one received power of physical sidelink feedback channel associated with the at least one of the plurality of the beams being usable and at least one received power of physical sidelink feedback channel associated with the at least one beam having the most suitable signal level and/or quality; and means for determining, based on the absolute difference or the relative difference, the one or more of the at least one of the plurality of beams for signal transmission.

In some embodiments, the signal level and/or quality is a reference signal received power.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

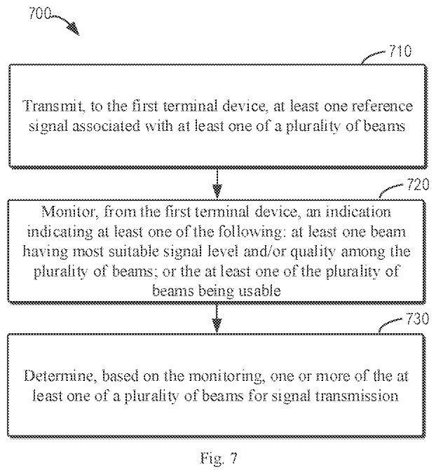

FIG. 8 is a simplified block diagram of a device 800 that is suitable for implementing embodiments of the present disclosure. The device 800 may be provided to implement the communication device, for example the first terminal device 110 or the second terminal device 120 as shown in FIG. 1A. As shown, the device 800 includes one or more processors 810, one or more memories 820 coupled to the processor 810, and one or more communication modules 840 coupled to the processor 810.

The communication modules 840 is for bidirectional communications. The communication modules 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2 to 7. The embodiments of the present disclosure may also be implemented by hardware or by a combination of software and hardware.

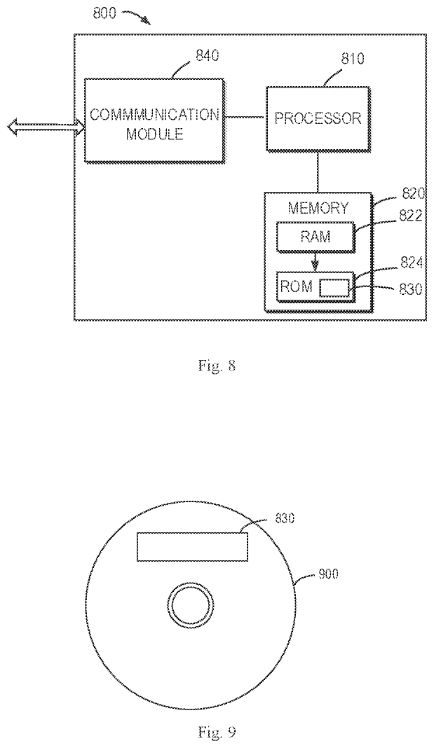

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or the method 700 as described above with reference to FIGS. 2-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first terminal device comprising:
at least one processor; and
at least one memory storing instructions that, when executed by the at least one processor, cause the first terminal device at least to:
determine usability of at least one of a plurality of beams associated with at least one reference signal transmitted by a second terminal device based on measured signal level and/or quality;
carry out beam-wise comparison among the at least one of the plurality of the beams determined usable, wherein the beam-wise comparison is based on the measured signal level and/or quality for identifying at least one beam having most suitable signal level and/or quality for signal transmission; and
transmit, to the second terminal device, an indication indicating at least one of the following: the at least one beam having the most suitable signal level and/or quality; or the at least one of the plurality of beams being usable.

2. The first terminal device of claim 1, wherein the first terminal device is caused to determine the usability of the at least one of the plurality of beams by:
measuring signal level and/or quality of the plurality of beams; and
based on the at least one of the plurality of beams having the signal level and/or quality above a threshold, determining that the at least one of the plurality of beams is usable.

3. The first terminal device of claim 1, wherein the first terminal device is further caused to:
store at least one of the following for being used in identifying the at least one beam having the most suitable signal level and/or quality for the signal transmission:
the measured signal level and/or quality; or
the determined usability.

4. The first terminal device of claim 1, wherein the first terminal device is caused to carry out the beam-wise comparison for identifying the at least one beam by:
based on signal level and/or quality of the at least one beam is larger than signal level and/or quality of other beams among the plurality of beams, determining that the at least one beam has the most suitable signal level and/or quality for the signal transmission.

5. The first terminal device of claim 1, wherein the first terminal device is caused to carry out the beam-wise comparison for identifying the at least one beam by:
based on signal level and/or quality of the at least one beam is larger than signal level and/or quality of other beams among the plurality of beams, determining that the at least one beam has the most suitable signal level and/or quality for the signal transmission, and wherein the at least one beam is at least one transmit beam, and the first terminal device is further caused to at least one of the following:
record the at least one transmit beam having the most suitable signal level and/or quality for the signal transmission as at least one best transmit beam; or
record at least one receive beam associated with the most suitable signal level and/or quality as at least one best receive beam.

6. The first terminal device of claim 1, wherein the at least one beam is at least one transmit beam, the plurality of beams are a plurality of transmit beams, and the first terminal device is caused to carry out the beam-wise comparison for identifying the at least one beam by:
determining that the at least one transmit beam has the most suitable signal level and/or quality for the signal transmission based on the following condition:
a pattern of transmit beam sweeping indicates that the at least one transmit beam is recorded as at least one best transmit beam but at least one receive beam corresponding to the at least one transmit beam is not recorded as at least one best receive beam.

7. The first terminal device of claim 1, wherein the first terminal device is caused to transmit the indication by:
transmitting, on a physical sidelink feedback channel resource being for at least one reference signal transmission using the at least one beam, an acknowledgement indicating the at least one beam being usable and having the most suitable signal level and/or quality for the signal transmission.

8. The first terminal device of claim 1, wherein the first terminal device is caused to transmit the indication by:
transmitting, on a physical sidelink feedback channel resource being for at least one reference signal transmission using the at least one of the plurality of beams, a non-acknowledgement indicating that the at least one of the plurality of beams is usable and does not have the most suitable signal level and/or quality for the signal transmission.

9. The first terminal device of claim 1, wherein the first terminal device is further caused to:
based on the at least one of the plurality of beams is not usable, prevent from transmitting on a physical sidelink feedback channel resource being for at least one reference signal transmission using the at least one of the plurality of beams.

10. The first terminal device of claim 1, the signal level and/or quality is a reference signal received power.

11. A second terminal device comprising:
at least one processor; and
at least one memory storing instructions that, when executed by the at least one processor, cause the second terminal device at least to:
transmit, to a first terminal device, at least one reference signal associated with at least one of a plurality of beams;
monitor, from the first terminal device, an indication indicating at least one of the following: at least one beam having most suitable signal level and/or quality among the plurality of beams; or the at least one of the plurality of beams being usable; and
determine, based on the monitoring, one or more of the at least one of a plurality of beams for signal transmission.

12. The second terminal device of claim 11, wherein the second terminal device is caused to monitor the indication by:
based on receiving, on a physical sidelink feedback channel resource being for reference signal transmission using the at least one beam, an acknowledgement, determining that the at least one beam being usable and having the most suitable signal level and/or quality for the signal transmission.

13. The second terminal device of claim 11, wherein the second terminal device is caused to monitor the indication by:
based on receiving, on a physical sidelink feedback channel resource being for reference signal transmission using the at least one of the plurality of beams, a non-acknowledgement, determining that at least one of the plurality of beams is usable and does not have the most suitable signal level and/or quality for the signal transmission.

14. The second terminal device of claim 11, wherein the second terminal device is further caused to
based on receiving, on a physical sidelink feedback channel resource being for reference signal transmission using the at least one of the plurality of beams, neither an acknowledgement nor a non-acknowledgement, determine that the at least one of the plurality of beams is not usable.

15. The second terminal device of claim 11, wherein the second terminal device is caused to determine the one or more of the at least one of the plurality of beams for signal transmission by:
measuring at least one received power of physical sidelink feedback channel associated with the at least one of the plurality of the beams being usable, the received power of physical sidelink feedback channel being for conveying the indication;
determining an absolute difference or a relative difference between at least one received power of physical sidelink feedback channel associated with the at least one of the plurality of the beams being usable and at least one received power of physical sidelink feedback channel associated with the at least one beam having the most suitable signal level and/or quality; and
determining, based on the absolute difference or the relative difference, the one or more of the at least one of the plurality of beams for signal transmission.

16. The second terminal device of claim 11, the signal level and/or quality is a reference signal received power.

17. A method comprising:
determining, at a first terminal device, usability of at least one of a plurality of beams associated with at least one reference signal transmitted by a second terminal device based on measured signal level and/or quality;
carrying out beam-wise comparison among the at least one of the plurality of the beams determined usable, wherein the beam-wise comparison is based on the measured signal level and/or quality for identifying at least one beam having most suitable signal level and/or quality for signal transmission; and
transmitting, to the second terminal device, an indication indicating at least one of the following: the at least one beam having the most suitable signal level and/or quality; or the at least one of the plurality of beams being usable.

18. The method of claim 17, wherein the at least one beam is at least one transmit beam, the plurality of beams are a plurality of transmit beams, and the first terminal device is caused to carry out the beam-wise comparison for identifying the at least one beam by:
determining that the at least one transmit beam has the most suitable signal level and/or quality for the signal transmission based on the following condition:
a pattern of transmit beam sweeping indicates that the at least one transmit beam is recorded as at least one best transmit beam but at least one receive beam corresponding to the at least one transmit beam is not recorded as at least one best receive beam.

19. The method of claim 17, wherein the first terminal device is caused to transmit the indication by:
transmitting, on a physical sidelink feedback channel resource being for at least one reference signal transmission using the at least one beam, an acknowledgement indicating the at least one beam being usable and having the most suitable signal level and/or quality for the signal transmission.

20. The method of claim 17, wherein the first terminal device is caused to transmit the indication by:
transmitting, on a physical sidelink feedback channel resource being for at least one reference signal transmission using the at least one of the plurality of beams, a non-acknowledgement indicating that the at least one of the plurality of beams is usable and does not have the most suitable signal level and/or quality for the signal transmission.
